(19) United States
(12) Patent Application Publication
(10) Pub. No.: US 2014/0251915 A1
(43) Pub. Date: Sep. 11, 2014

(54) WATER TREATMENT TO REMOVE MULTIVALENT CATIONS

(71) Applicant: Liberty Hydro, Inc., South Charleston, WV (US)

(72) Inventors: John R. Sawyer, Charleston, WV (US); Vincent Maurice Davis, Charleston, WV (US)

(21) Appl. No.: 14/354,344

(22) PCT Filed: Nov. 5, 2012
(86) PCT No.: PCT/US2012/063599

§ 371 Date: Apr. 25, 2014

Related U.S. Application Data
(60) Provisional application No. 61/555,007, filed on Nov. 3, 2011.

(51) Int. Cl. C02F 1/42

(52) U.S. Cl. CPC C02F 1/42
USPC 210/681

(57) ABSTRACT

A method of removing di-, tri- and tetra-valent cations from aqueous media with a relatively short residence time, by causing cations and/or hydrous metal oxides to bind to a negatively charged media immobilized on a support structure thereby incorporating the cations into or onto the structure and removing them from the aqueous media. In another aspect, the present invention relates to a structure useful for removing di-, tri- and tetra-valent cations from aqueous media. The structure is designed to facilitate adherence of cations and/or hydrous metal oxides to the structure thereby incorporating the cations into or onto the structure and removing them from the aqueous media.

### BACKGROUND OF THE INVENTION

1. Field of the Invention

The present invention relates to methods and apparatus for water treatment to remove impurities. More specifically, the present invention relates to water treatment to reduce the content of contaminants such as iron, manganese and aluminum.

2. Background of the Invention

There are several contaminants in surface waters that are of considerable concern due to their effects on wildlife as well as humans. Among those heavily regulated are iron, manganese, and aluminum.

Previous work has demonstrated these may be removed by sufficient time at a suitable pH, at which the multivalent (e.g. divalent, trivalent or tetravalent) cations will hydrolyze, and react to form flocs, and ultimately form particles large enough to settle out of the water. While these processes are effective, they do not always take place on a timescale that is suitable for removal of the cations from water before discharge.

Thus, a new method of producing a larger particle size of particles containing multivalent cations in a short time period is needed in order to meet federally mandated discharge limits in an efficient and economical manner.

### SUMMARY OF THE INVENTION

In one aspect, the present invention is generally directed toward a method of removing di-, tri- and tetra-valent cations from aqueous media with a relatively short residence time, by causing cations to adhere to a negatively charged media immobilized on a support structure thereby incorporating the cations into or onto the structure and removing them from the aqueous media.

In another aspect, the present invention relation to a structure useful for removing di-, tri- and tetra-valent cations from aqueous media. The structure is designed to facilitate adherence of cations to the structure thereby incorporating the cations into or onto the structure and removing them from the aqueous media.

### DETAILED DESCRIPTION OF EMBODIMENTS OF THE INVENTION

It is to be understood that there are several ways of carrying out the invention, and that this description is intended to be illustrative, and not restrictive.

It must be noted that as used herein and in the appended claims, the singular forms “a”, “an”, and “the” include plural references unless the context clearly dictates otherwise. Furthermore, the terms “a” (or “an”), “one or more” and “at least one” can be used interchangeably herein. The terms “comprising”, “including”, “having” and “constructed from” can also be used interchangeably.

In a first aspect aspect, the invention relates to a method of removing di-, tri- and tetra-valent cations from aqueous media. In the invention, the multivalent cations are adhered to a structure thereby incorporating the cations into or onto the structure and removing them from the aqueous media. The invention provides the advantage that the multivalent cations can be removed in a relatively short residence time of not more than one hour, or not more than thirty minutes, or not more than fifteen minutes.

One suitable structure comprises porous support with a suitable media deposited thereon or incorporated therein. The media must be capable of adhering to certain multivalent cations when the media is located in an aqueous environment. Multivalent cations of iron, manganese, aluminum, nickel, copper and chromium are exemplary of the types of cations to be removed by the present invention.

One suitable structure is made by depositing a media such as diatomaceous earth (DE) on a support structure such as a reticulated foam structure. The DE has a surface charge that attracts multivalent cations. Cations contained in hydrous metal oxide compounds selected from FeOOH, Fe(OH)₃, Al(O)ₓ(OH)_{y}, and Mn(O)ₓ(OH)_{y} wherein x is an integer of from 0 to 3 and y is an integer of from 0 to 7, are good candidates for removal by the present invention by binding to the surface of the media. X and y may be selected to provide a total negative valency that matches the valency of the particular cation in question. These hydrous metal oxides continue to undergo a particle growth process even when located on the DE, thereby removing additional species containing metal cations from the water. The open spaces in porous structure of the support provide space to sequester the hydrous metal oxides onto the DE surface, while maintaining cation removal efficiency and flow through the structure by providing sufficient porosity to allow flow of the aqueous media through the structure and create a large surface area upon which the DE is deposited.

Other media that may be used in place of the DE are sand or other silicaceous materials, zeolites and mixtures thereof. The materials used as the media to sequester the multivalent cations must have a negative surface charge. DE, sand and certain types of zeolites have a negative surface charge and thus can attract the hydrous metal oxides containing the multivalent cations that are to be effectively removed from the aqueous media. Other surfaces that have a negative charge on the surface will work as well, including conductive surfaces which have been connected to a source of electricity to cause them to be negatively charged. Such conductive surfaces can be provided by fabrication of the support structure from a conductive polymer or by coating the support structure with a conductive polymer.

Suitable supports include a porous structure such as a reticulated foam structure. The support for use in the apparatus and methods of the invention may be a reticulated foam structure made from any suitable material, but preferably is made from polyether or polyurethane. The negatively charged media may be adhered to the support by any suitable adherent such as any suitably tacky material possessing the desired resistance to continuous water contact. Alternatively, the support material may itself be tacky, and used directly to adhere the negatively charged media thereto without the need for a further adherent. Also, the support may be manufactured with the DE, sand, zeolite or other suitable negatively charged media impregnated into or deposited in the pores of the support structure.

These methods provide a support such as a reticulated foam with an open structure which provides a low pressure drop across the structure when placed in flowing aqueous media, and also provides sufficient contact area to remove iron, manganese, aluminum, and other multivalent cations from the aqueous media as it flows through the porous structure. The surface area is dependent to some extent on the material adhered to the foam, and the surface area may range from about 1 m²/g to about 300 m²/g, or from about 50 m²/g to about 200 m²/g. An effective range of porosity for the support structure is from about 1 to about 15 pores per centimeter, or from about 2 to about 12 pores per centimeter. A typical pressure drop will be less than 10 inches of water, or less than 5 inches of water.

Another method in accordance with the invention involves location of small particles having an average particle size in the range of 1 to 100 microns of a media such as DE, sand or zeolite media on the surface of a porous, larger particle such as a pellet having a particle size of from about 1 mm to about 100 mm, which serves as the support structure. The porous, larger particles are preferably of an irregular shape and may be formed from reticulated foram. In this embodiment, the pellets can be employed in the form of a packed bed that may be located in a suitable housing. Again, the packed bed should create a relatively low pressure drop across the bed when located in flowing aqueous media.

Still another method is to use a shaped support, such as an elongated cylinder, coated on the outside, which, when packed loosely provides sufficient interstitial volume for the deposition of the hydrous metal oxides. Additional shapes are readily apparent, such as a rectangular solid with one long dimension, a shape with rectangular or square cross-section shapes with a sinusoidal or other irregular shape along the length of the third axis (such as a crinkle-cut potato), or other shapes used for structured and unstructured packings in mass transfer applications.

The foregoing embodiments are susceptible to considerable variation in practice. Accordingly, the embodiments are not intended to be limited to the specific exemplifications set forth hereinabove. Rather, the foregoing embodiments are within the spirit and scope of the appended claims, including the equivalents thereof available as a matter of law.

The applicant(s) do not intend to dedicate any disclosed embodiments to the public, and to the extent any disclosed modifications or alterations may not literally fall within the scope of the claims, they are considered to be part hereof under the doctrine of equivalents.

1. A method for removing one or more impurities from aqueous media, said method comprising the step of binding multivalent cations in an aqueous media to a negatively charged media immobilized on a support structure.

2. The method as claimed in claim 1, wherein the negatively charged media is selected from diatomaceous earth, sand or other silicaceous materials, zeolite and mixtures thereof.

3. The method as claimed in claim 1 wherein said support structure is a reticulated foam structure.

4. The method as claimed in claim 1 wherein the multivalent cations are comprised in compounds selected from FeOOH, Fe(OH)₃, Fe(O)ₓ(OH)_{y}, Al(O)ₓ(OH)_{y}, and Mn(O)ₓ(OH)_{y}, wherein x is an integer of from 0 to 3 and y is an integer of from 0 to 7.

5. The method as claimed in claim 1, wherein the media comprises diatomaceous earth.

6. The method as claimed in claim 1, wherein the negatively charged media immobilized on the support structure creates a pressure drop of less than 10 inches of water when located in a flowing aqueous media.

7. The method as claimed in claim 1, wherein the support structure with the negatively charged media immobilized thereon has from about 1 to about 15 pores per centimeter.

8. The method as claimed in claim 1, where the support structure is a reticulated foam structure comprising a material selected from polyether and polyurethane.

9. The method as claimed in claim 1, wherein the negatively charged media is adhered to the support structure by a tacky material having sufficient resistance to continuous water contact to maintain the negatively charged media adhered to the support structure in use.

10. The method as claimed in claim 1, wherein the support structure is sufficiently tacky to adhere the negatively charged media directly to the support structure.

11. The method as claimed in claim 1, wherein the negatively charged media is selected from sand and/or zeolite.

12. The method as claimed in claim 1, wherein the negatively charged media is impregnated in or deposited into the support structure during a process of manufacturing the support structure.

13. The method as claimed in claim 1, wherein the negatively charged media is in a form of small particles, the support structure comprises porous larger particles and the small particles of negatively charged media are immobilized on a surface of the porous larger particle to form pellets.

14. The method as claimed in claim 14, wherein the pellets are employed in the method as a packed bed.

15. The method as claimed in claim 1, wherein said support structure is a three-dimensional object coated on an outer surface with media, which structure, when packed loosely provides sufficient interstitial volume for deposition of hydrous metal oxides.

16. The method as claimed in claim 15, wherein said support structure is selected from cylindrical, cubical, sinusoidal and a rectangular solid.
